(19) United States
(12) Patent Application Publication
(10) Pub. No.: US 2024/0056654 A1
(43) Pub. Date: Feb. 15, 2024

(54) METHOD FOR PLAYBACK OF A VIDEO STREAM BY A CLIENT

(71) Applicant: RHEINISCH-WESTFÄLISCHE TECHNISCHE HOCHSCHULE (RWTH) AACHEN, Aachen (DE)

(72) Inventors: Hossein Bakhshi GOLESTANI, Munich (DE); Mathias WIEN, Aachen (DE); Christian ROHLFING, Aachen (DE)

(21) Appl. No.: 18/260,755

(22) PCT Filed: Nov. 30, 2021
(86) PCT No.: PCT/EP2021/083632

§ 371 Date: Jul. 7, 2023

(30) Foreign Application Priority Data
Jan. 12, 2021 (DE) 10 2021 200 225.0

(51) Int. Cl. H04N 21/81; H04N 19/597; H04N 21/462

(52) U.S. Cl. CPC H04N 21/816; H04N 19/597; H04N 21/4621

(57) ABSTRACT

The invention relates to a method for playback of a video stream by a client, wherein the video stream has frames from exactly one camera in relation to an object moving relative thereto, from different positions, the method comprising the steps of
Receiving a video stream from an encoder,
decoding the received video stream using camera parameters and geometry data,
playing back the processed video stream.

### BACKGROUND

At the present time, the digital encoding of video signals can be found in many forms. For instance, digital video streams, e.g., are provided on data carriers, such as, e.g., DVDs, Blu-ray, or as download or video stream, respectively (e.g. also for video communication). It is the goal of the video encoding thereby to not only send representatives of the pictures to be transmitted, but to simultaneously also keep the data consumption low. On the one hand, this makes it possible to store more content on storage-limited media, such as, e.g., DVDs or to permit the simultaneous transport of (different) video streams for several users.

A differentiation is thereby made between lossless and lossy encoding.

All approaches have in common that information for following pictures is predetermined from previously transmitted pictures.

Current analyses assume that the proportion of such encoded video signals will account for a proportion of 82% of the entire network traffic in 2022 (compared to 75% in 2017), see Cisco Visual Networking Index: Forecast and trends, 2017-2022 (white paper), Cisco, February 2019.

It can be seen from this that any savings that can be achieved here will lead to large savings of data volumes and thus to savings of electrical energy for the transport.

As a rule, an encoder, a carrier medium, e.g. a transmission channel, and a decoder is required. The encoder processes raw video data. As a rule, a single picture is thereby referred to as frame. A frame, in turn, can be understood as a collection of pixels. One pixel thereby represents one point in the frame and specifies its color value and/or its brightness.

For example, the data quantity for a following frame can be reduced thereby when a majority of the information is/are already included in one or several previously encoded frame(s). It would then be sufficient, e.g., if only the difference is transmitted. The knowledge that many identical contents can often be seen in consecutive frame is utilized thereby. This is the case, e.g., when a camera captures a certain scene from a viewing angle and only few things change, or when a camera moves or rotates slowly through the scene (translation and/or affine motion of the camera).

This concept reaches its limits, however, when a large proportion changes between frames, as it occurs, e.g., in the case of a (fast) motion of the camera within a scene or a motion of objects within the scene, respectively. In the worst case, any pixel of two frames can be different in this case.

Methods for multi-camera systems are known from the prior art, for example from the European patent application EP 2 541 943 A1. However, these multi-camera systems are designed for the use of a previously known setup of cameras with previously known parameters.

However, a completely different requirement profile results when a camera is used, i.e. a monocular recording system. In many areas, e.g. when driving autonomously, in the case of drones, in the case of social media video recordings, or also in the case of bodycams, or action cams, in contrast, only a single camera is used as a rule. However, it is necessary precisely here to keep the used storage and/or a data quantity to be transmitted small.

### Object

Based on this, it is an object of the invention to provide an improvement of single camera systems.

### BRIEF DESCRIPTION OF THE INVENTION

The object is solved by means of a method according to claim 1. Further advantageous designs are subject matter of the dependent claims, of the description, and of the figures.

### BRIEF DESCRIPTION OF THE FIGURES

FIG. 1 shows schematic flowcharts according to aspects of the invention,

FIG. 2 shows schematic flowcharts according to further aspects of the invention,

FIG. 3 shows schematic flowcharts according to further aspects of the invention,

FIG. 4 shows a schematic illustration for describing conceptional questions, and

FIG. 5 shows an exemplary relation of frames according to further aspects of the invention.

### DETAILED DESCRIPTION OF THE INVENTION

The invention will be described in more detail below with reference to the figures. It is important to note thereby that different aspects are described, which can each be used individually or in combination. This means that any aspect can be used with different embodiments of the invention, unless explicitly described otherwise as pure alternative.

As a rule, reference will furthermore always be made below to only one entity for the sake of simplicity. Unless noted explicitly, however, the invention can in each case also have several of the respective entities. In this respect, the use of the word “a” is to only be understood as an indication that at least one entity is used in a simple embodiment.

As far as methods are described below, the individual steps of a method can be arranged and/or combined in any sequence, unless anything to the contrary results explicitly from the context. Unless characterized expressly otherwise, the methods can furthermore be combined with one another.

We will discuss the different aspects of the invention in connection with a complete system of encoder and decoder below. Errors, which can occur between the encoding and decoding, will not be examined below because they are not relevant for understanding the decoding/encoding.

In the common video delivery systems, the encoder is based on prediction. This means that the better an encoded frame can be predicted from a previously decoded frame, the less information (bit(s)) has to be transmitted.

The current approaches pursued the approach to predict frames based on similarities between the frames in a two-dimensional model.

It must be noted, however, that the recording of videos mostly takes place in the three-dimensional space.

With computing power, which is now available, it is possible to determine/estimate depth information on the part of the encoder and/or of the decoder.

A three-dimensional motion model can thus also be provided within the invention. Without limiting the general nature of the invention, it is possible thereby to also use the invention with all current video decoders/encoders, provided that they are equipped accordingly. In particular, Versatile Video Coding ITU-T H.266/ISO/IEC 23090-3 can be added to the invention.

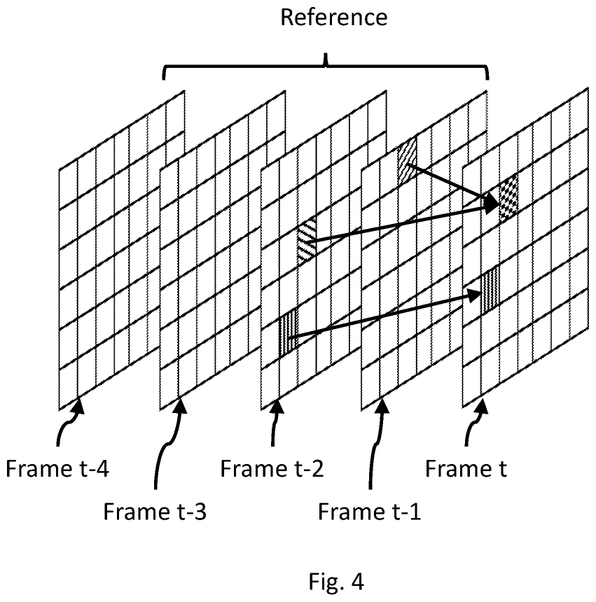

The invention is thereby based on the idea of the motion-compensated prediction. In order to motivate this, reference is made below to FIG. 4. A video of (consecutive) encoded pictures is thereby watched from two-dimensional frames (i.e. a sequence). One frame is thereby also referred to as two-dimensional representation. Due to the temporal redundancy between consecutive frames, a frame (to be encoded) can be predicted at the point in time t from previously encoded frames (t−1, t−2 . . . (illustrated t−4) without being limited to previous frames). These previous frames are also referred to as reference (reference frames, reference pictures). It is important to mention thereby that the frame sequence does not necessarily have to be a temporal sequence here, but that the illustrated sequence and the decoded/encoded sequence can be different. This means that not only information from temporally earlier frames, but also information from temporally following (in the illustration/temporal sequence future) frames can be used for the decoding/encoding.

If the motion-compensated prediction is precise enough, it is sufficient to only transmit the difference between the prediction and the frame to be encoded, the so-called prediction error. The better the prediction, the fewer prediction errors have to be transmitted, that is, the less data has to be transmitted or stored, respectively, between encoder and decoder.

This means that in terms of the encoder, the efficiency increases.

The conventional encoders are based on the similarity of frames in a two-dimensional model, i.e. only translations and/or affine motions are considered. However, there is a number of motions, which cannot simply be expressed as 2D model. This invention thus uses an approach, which is based on the three-dimensional environment, in which the sequence is detected and a 3D motion model can be displayed therefrom.

Practically speaking, the video recording is analogous to the projection of a three-dimensional scene into the two-dimensional plane of the camera. Due to the fact however, that the depth information gets lost during the projection, the invention provides for a different provision.

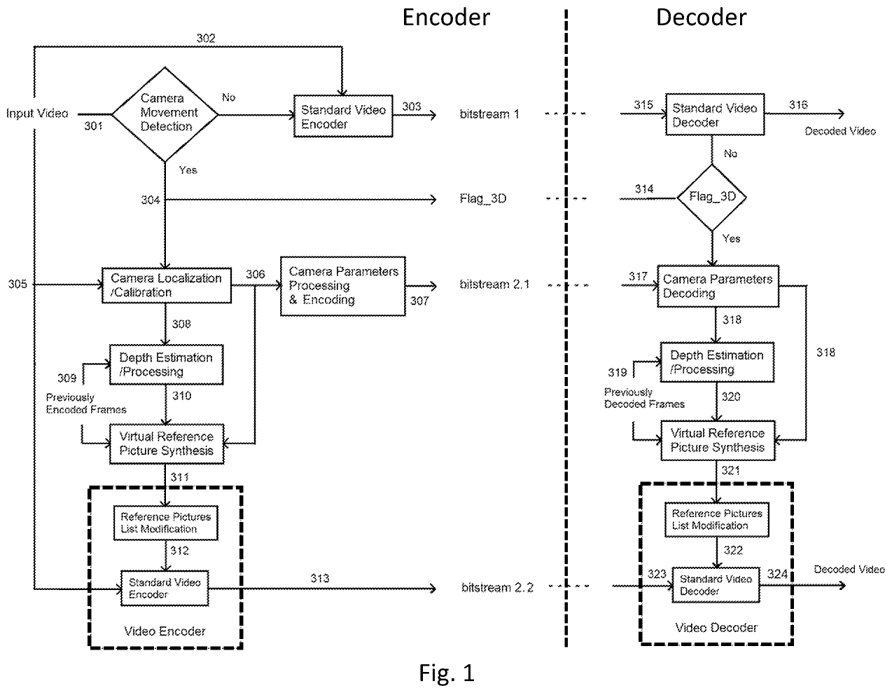

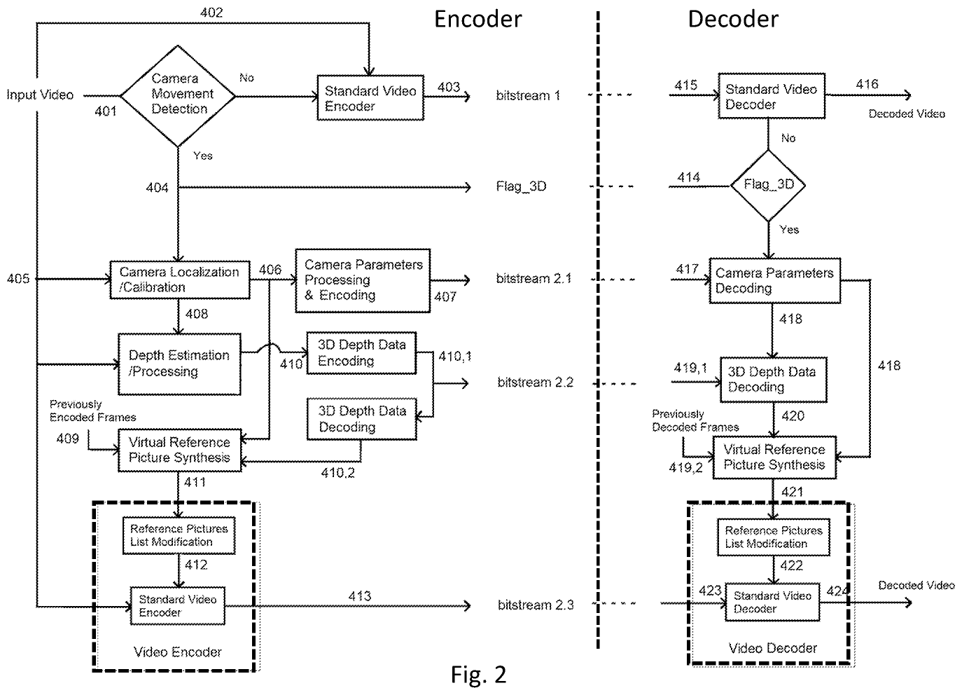

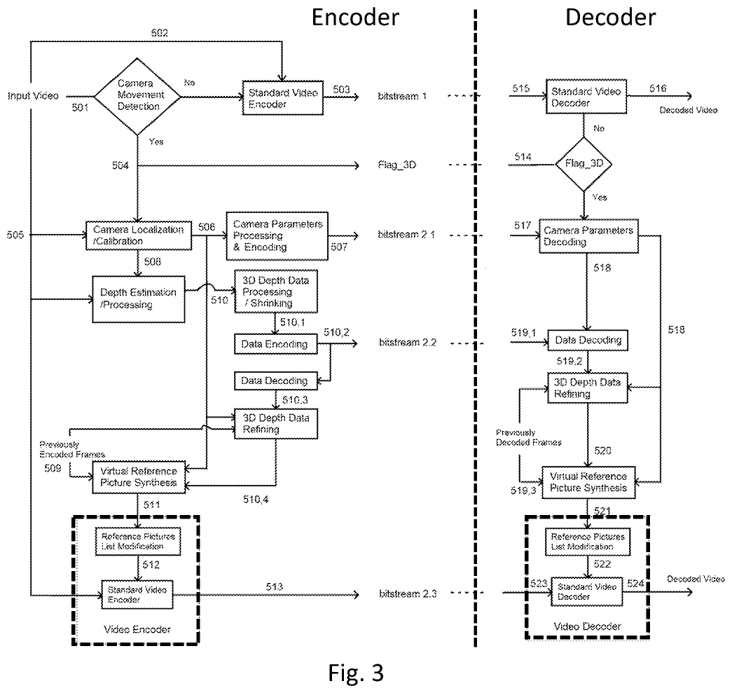

In the example of the flowchart according to FIG. 1, the 3D information is reconstructed on the part of the decoder, while in the example of the flowchart according to FIG. 2, the encoder provides the 3D information (in compressed form), and the decoder only uses it. In the example of the flowchart according to FIG. 3, a mixed form is provided, in the case of which the encoder provides the (coarse) 3D information, and the decoder further processes the 3D information in order to improve it.

It is obvious that in the first case, the necessary bandwidth/storage capacity can be smaller than in the second or third case. On the other hands, the requirements on the computing power in the first case are high for the encoder and the decoder, while in the second case the requirements on the computing power are lower for the decoder and are highest for the encoder. This means that based on the available options, different scenarios can be operated. In particular during a query for a video stream, it can thus be provided that, e.g., a decoder makes its properties known to the encoder, so that the encoder can potentially forgo the provision of (precise) 3D information because the decoder provides a method according to FIG. 1 or 3.

We assume below that the camera is any camera and is not bound to a certain type.

Reference will be made below to a monocular camera with unknown camera parameters as the most difficult application, but without thereby ruling out the use of other camera types, such as, e.g., light field, stereo camera, etc.

A conclusion can be drawn thereby to the camera parameters CP and geometry data GD. A conclusion can be drawn to the camera parameters CP, e.g., by means of methods, such as structure from motion, simultaneous localization, and mapping or sensors.

If such data is known from certain camera types, e.g. stereo cameras and/or from additional sensors, such as, e.g., LIDAR sensors, gyroscopes, etc., they can alternatively or additionally be transmitted or processed and can thus reduce the computing effort or make it obsolete. The camera parameters CP can typically be determined from sensor data from gyroscopes, inertial measurement unit (IMU), location data from a global positioning system (GPS), etc., while geometry data GD is determined from sensor data of a LIDAR sensor, stereo cameras, depth sensors, light field sensors, etc. If camera parameters CP as well as geometry data GD is available, the decoding/encoding becomes easier and qualitatively better as a rule.

The encoder SRV can receive, e.g., a conventional video signal Input Video in step 301. This video signal can advantageously be monitored for motion, i.e. a relative motion of the camera. If a relative motion of the camera is detected, the input video signal Input Video can be subjected to an encoding according to the invention, otherwise, if no relative motion of the camera is detected, the signal can be subjected to a conventional encoding, as before, and can be provided to the decoder C as suggested in step 303, 403, 503.

In embodiments, a camera motion can be detected on the part of the encoder, e.g. by means of visual data processing of the video signal and/or by means of sensors, such as, e.g., an IMU (Inertial Measurement Unit), a GPS (Global Positioning System), etc.

If, in contrast, a motion is detected, a corresponding flag Flag 3D or another signaling can be used in order to signal the presence of content according to the invention according to step 304, 404, 504, should it not already be detectable per se from the data stream.

If a camera motion is determined, the (intrinsic and extrinsic) camera parameters CP can be estimated/determined in step 306, 406, 506, as suggested in step 305, 405, 505.

Techniques, such as, e.g., visual data processing, such as, e.g., Structure-from-Motion (SfM), Simultaneous Localization and Mapping (SLAM), Visual Odometry (V.O.), or any other suitable method can be used for this purpose.

It goes without saying that the camera parameters CP can also be estimated/determined/adopted as known value by means of other sensors.

Without limiting the general nature of the invention, these camera parameters CP can be processed and encoded in step 307, 407, 507, and can be provided to the decoder C separately or embedded into the video stream VB.

The geometry in the three-dimensional space can be estimated/determined in step 310, 410, 510. The geometry in the three-dimensional space can in particular be estimated from one or several previously encoded frames (step 309) in step 310. The previously determined camera parameters CP can be included in step 308 for this purpose. In the embodiments of FIGS. 2 and 3, the 3D geometry data can be estimated/determined from “raw” data. In the embodiment of FIG. 1, this data can be estimated/determined from the encoded data. The visual quality will typically be better in the embodiments of FIGS. 2 and 3 than in the embodiment of FIG. 1, so that these embodiments can provide higher-quality 3D geometry data.

In order to estimate the geometry in the three-dimensional space, so-called Multi-View Computer Vision techniques can be used, without thereby ruling out the use of other techniques, such as, e.g., possibly available depth sensors, such as, e.g., LIDAR or other picture sensors, which allow for a depth detection, such as, e.g., stereo cameras, RGB+D sensors, light field sensors, etc.

The geometry determined in this way in the three-dimensional space can be represented by a suitable data structure, e.g. a 3D model, a 3D network, 2D depth maps, point clouds (sparsely populated or dense), etc.

The video signal VB can now be encoded on the basis of the determined geometry in the three-dimensional space in step 312, 412, 512.

The novel motion-based model can now be applied to the reproduced three-dimensional information.

For example, a reference picture can be determined/selected in step 311 for this purpose. This can then be presented to the standard video encoder in step 312.

The encoding following now can obviously be used for one, several, or all frames of a predetermined quantity. It goes without saying that the encoding can also be based on one, several, or all previous frames of a predetermined quantity in the corresponding manner.

It can also be provided that the encoder SRV processes only some spatial regions within a frame in the specified manner according to the invention and others in a conventional manner.

As already specified, a standard video encoder can be used. An additional reference can thereby be added to the list of the reference pictures (in step 311) or an existing reference picture can be replaced. As already suggested, only a certain spatial region can likewise be overwritten with the new reference.

The standard video encoder can be enabled independently thereby to select that reference picture, which has a favorable characteristic, e.g. a high compression with small distortions (rate-distortion optimization), on the basis of the available reference pictures.

The standard video encoder can thus encode the video stream by using the synthetized reference and can provide it to the decoder C in step 313, 413, 513.

As also in previous methods, the encoder SRV can start again with a detection according to step 301 at corresponding re-entry points and can run through the method again.

Re-entry points can be set at specified time intervals, on the basis of channel characteristics, the picture rate of the video, the application, etc.

The 3D geometry can thereby in each case be newly reconstructed in the three-dimensional space or can further develop an existing one. With increasingly new frames, the 3D geometry continues to grow, until it is started again at the next re-entry point.

The same action can take place on the decoder side C, wherein in FIGS. 1 to 3, encoder SRV and decoder C are arranged horizontally at approximately the same height in their functionally corresponding components.

The decoder C can thus initially check whether a corresponding flag FLAG 3D or another signaling was used.

If such a signaling (Flag 3D is 0, e.g.) is not present, the video stream can be treated by default in step 316. Otherwise, the video stream can be treated in a new way according to the invention.

Camera parameters CP can initially be received in step 317, 417, 517. The received camera parameters CP can be processed and/or decoded in optional steps 318.

These camera parameters CP can be used, e.g., for a depth estimation as well as for the generation of the geometry in the three-dimensional space in step 320 on the basis of previous frames 319.

As a whole, the same strategy as in the case of the encoder (steps 309 . . . 312, 409 . . . 412, 509 . . . 512) can be used in corresponding steps 319 . . . 332, 419 . . . 432, 519 . . . 532 in relation to the reference pictures. It is possible, e.g., to render the synthetized reference picture in step 321, in that the previously decoded frame (step 319) is transformed into the frame, which is to be decoded, by guiding the decoded camera parameters CP (step 318) and the geometry in the three-dimensional space (step 320).

Lastly, the video stream, which is processed according to the invention, can be decoded in step 323, 423, 523 by means of a standard video encoder and can be output as decoded video stream 324, 424, 524.

The decoder should thereby typically be synchronous with the encoder in relation to the settings, so that the decoder C uses the same settings (in particular for the depth determination, reference generation, etc.) as the encoder SRV.

In contrast to the embodiment of FIG. 1, the geometry in the three-dimensional space can be estimated from raw video frames in step 405 in the embodiment of FIG. 2. An (additional) bit stream 410.1, which is, e.g., object of further processing, e.g. decimation (lossless/lossy) compression and encoding and which can be provided to the decoder C, can be generated thereby from the data. As in the decoder C, this provided bit stream 2.2 can now also be reconverted in step 410.2 (to ensure the congruence of the data) and can be provided for the further processing in step 411.

The geometry in the three-dimensional space can likewise also be maintained beyond a re-entry point. However, the method also allows for the constant improvement of the geometry in the three-dimensional space on the basis of previous and current frames. This geometry in the three-dimensional space can suitably be the object of further processing, e.g. decimation (e.g. mesh decimation), (lossless/lossy) compression/encoding.

The decoder C can receive and decode the bit stream 2.2 received in step 419.1 with the data relating to the geometry in the three-dimensional space in the corresponding manner.

The decoded geometry in the three-dimensional space can then be used in step 420.

The decoder can obviously operate faster in this variation because the decoding requires less effort than the reconstruction of the geometry in the three-dimensional space (FIG. 1).

While a highly efficient method in relation to the bit rate reduction is introduced in the embodiment of FIG. 1, a lower bit rate reduction can be attained with the embodiment of FIG. 2, but for which the complexity on the part of the decoder C decreases. The embodiment of FIG. 3 combines aspects of the embodiments of FIG. 1 and FIG. 2, distributes the complexity, and allows for a flexible and efficient method.

The concept of the embodiment of FIG. 3 essentially differs from the embodiment of FIG. 2 in that the geometry in the three-dimensional space, i.e. the 3D data in step 510.1, roughly represent the original geometry in the three-dimensional space, i.e. in stripped-down version, so that the required bit rate for this decreases. Each suitable method for the data reduction, such as, e.g., sub-sampling, coarse quantization, transformation encoding, and dimension reduction, etc., can be used for this purpose, without being limited thereto.

The 3D data minimized in this way can be encoded as before in step 510.2 and can be provided to the decoder C. The bit stream 510.1/510.2 can be the object of further processing, e.g. decimation, (lossless/lossy) compression, and encoding, which can be provided to the decoder C. As in the decoder C, this provided bit stream 2.2 can now also be reconverted in step 510.3 (to ensure the congruence of the data) and can be provided for the further processing in step 511. The previously encoded frames 509 and the camera parameters 506 can thereby be used for the finer development of the 3D data.

The decoder C can receive the encoded and minimized 3D data in step 519.1 in the corresponding manner and can decode it in step 519.2 and can therefore be provided to the encoder SRV for the processing. The previously encoded frames 519.3 and camera parameters 518 can thereby be used for the finer development of the 3D data.

This means that a video stream VB is received from the encoder SRV, e.g. a streaming server, in a first step 315, 415, 515 in all embodiments of the decoder C.

The client C decodes the received video stream VB by using camera parameters CP and geometry data GD, and plays it back subsequently as processed video stream AVB in step 324, 424, 524.

As shown in FIGS. 1 to 3, the camera parameters CP can be received from the encoder SRV in step 317, 417, 517 (e.g. as bit stream 2.1) or can be determined from the received video stream VB in embodiments of the invention.

In embodiments of the invention, geometry data GD can be received from the encoder SRV (e.g. as bit stream 2.2) or can be determined from the received video stream VB.

It can in particular be provided that prior to receiving the video stream. VB, the decoder C signals its ability to process to the encoder SRV. A set of options for the processing can thereby also be delivered, so that the encoder can provide the suitable format. The provided format can have a corresponding encoding with respect to setting data for this purpose.

In one embodiment of the invention, the geometry data has depth data.

In summary, it is important to point out once again that in the case of FIG. 1, a 3D reconstruction is used on the part of the encoder as well as of the decoder. In the example of FIG. 2, a 3D reconstruction is performed only by the encoder and is provided to the decoder. This means that the decoder does not have to perform a 3D reconstruction but can use the 3D geometry data provided by the encoder. As a rule, the estimation of the 3D geometry data on the part of the encoder is thereby simpler than on the part of the decoder. In particular when the computing power on the part of the decoder is limited, the design according to FIG. 2 is advantageous. In the case of FIG. 3, a 3D reconstruction is performed by the encoder and is provided to the decoder, as in FIG. 2. However, only a coarse version of the 3D geometry data is provided thereby. The bit rate for the 3D geometry data can be reduced thereby. However, the decoder has to now complete/refine the 3D geometry data at the same time.

The selection of the method (e.g. according to FIG. 1, FIG. 2, or FIG. 3) can be negotiated by the encoder and the decoder. This can take place, e.g., on the basis of previous knowledge (e.g. computing power) or also via a control/feedback channel (adaptive) in order to also consider, e.g., changes in the transmission capacity. In a broadcast scenario, which is directed to several decoders, the design according to FIG. 2 will generally be preferred.

Even if the invention is described in relation to methods, the person of skill in the art understands that the invention can also be provided in hardware, in particular hardware set up by software. Common decoding/encoding units, special computing units, such as GPUs and DSPs as well as solutions based on ASICs or FPGAs can be used for this purpose without ruling out the applicability of general microprocessors thereby.

The invention can accordingly in particular also be embodied in computer program products for setting up a data processing plant for carrying out a method.

It is possible with the invention to achieve the most significant savings possible with the bit rate of several percent, if correspondingly encodable scenes are present.

It shall initially be assumed below that a continuous video recording is to be encoded at a certain point in time. Some frames are already encoded thereby and a further frame, the “to-be-encoded frame” is to now be encoded. Depending on where in the succession the frame is located and/or depending on available data rate or video encoding setting, respectively, this “to-be-encoded frame” can be encoded by means of intra-prediction or inter-prediction tools. Intra-prediction tools would typically be used, e.g., for each first frame of a group of pictures (in short GOP), e.g. the 16^{th} frame (i.e. frame with ordinal numbers 0, 16, 32, . . . ), while inter-prediction tools would be used for the “intermediate frames” for this purpose.

The frames, which are to be encoded by means of inter-prediction tools, are of special interest in the context of the invention, i.e. for example the frames 1-15, 17-31, 33-47, . . . , . . . .

It is the essential idea in the case of inter-prediction tools to use a temporal similarity between consecutive frames. If, similarly to any frame, a block of a frame to be encoded is in the previously encoded frame (e.g. due to a relative motion), reference can simply be made to this already encoded block instead of encoding this block again. This process can be referred to as motion compensation. A list is used for this purpose, which is new for each frame, of previously encoded frames and which can be used as reference for the motion compensation. This list is also referred to as reference picture list. In essence, the encoder can divide the frame to be encoded into several non-overlapping blocks thereby. The block generated in this way can subsequently be compared with previously encoded blocks according to the list corresponding thereto, in order to find a close, preferably best match. The relative 2D position of the respectively found block (i.e. the motion vector) and the difference between the generated block and the found block (i.e. the residual signal) can then be encoded (together with further generated blocks, the position thereof and the differences thereof).

In the context of the invention, at least one novel reference pictures is generated based on 3D information and is added to this reference picture list or is inserted instead of a present reference picture. For this purpose, the camera parameters CP for a single (monocular) camera, and for the 3D scene geometry geometry-data GD are generated from a set of 2D pictures, which were detected by the moving monocular camera.

A novel reference picture based on 3D information is generated from this for the frames to be encoded, e.g. in that the content of conventional reference pictures is distorted to the position of the picture to be encoded. This distortion process is guided by the generated/estimated camera parameters CP and geometry data GF for the 3D scene geometry. The novel reference picture synthesized in this way is generated based on 3D information and added to this reference picture list.

The novel reference picture generated in this way allows for an improved performance in relation to the motion compensation, i.e. requires a smaller bit rate than conventional reference pictures in the reference picture list. The bit rate required at the end can also be decreased thereby and the encoding gain can be increased.

Various approaches can be used in order to be able to keep the run time of the encoder low.

It is important to note on the one hand that the synthesis of reference pictures on the part of the decoder is time consuming. It can be sufficient, however, to use the encoder with the novel 3D reference picture only for one or several subregions/regions in the frame to be encoded, e.g. 20%-30% of the surface/pixel, namely in particular for those, in the case of which there is a good inter-frame prediction by means of optimization. This shall be illustrated as follows in an exemplary manner. It shall be assumed that there are 3 references R1, R2, R3D, and a frame to be encoded shall be divided into non-overlapping blocks. R3D would then be one of the references provided by the invention. The encoder would then initially select a first block and would check which one is the most similar block in one of the references; this would then be carried out gradually for each block. R3D is typically found in 20%-30% of the cases, while R1 or R2 is found in the rest of the cases. This information which reference picture is used for which block, can be fed into the video bit stream. The decoder can then simply read this information and generate the novel reference picture based on 3D information at least for these regions, i.e. not for the entire region. This means that unlike the encoder, it may sometimes be sufficient for the decoder if only the used portion of the reference R3D is generated for the inter-prediction, while it is not necessary to likewise generate the other portions of the reference R3D.

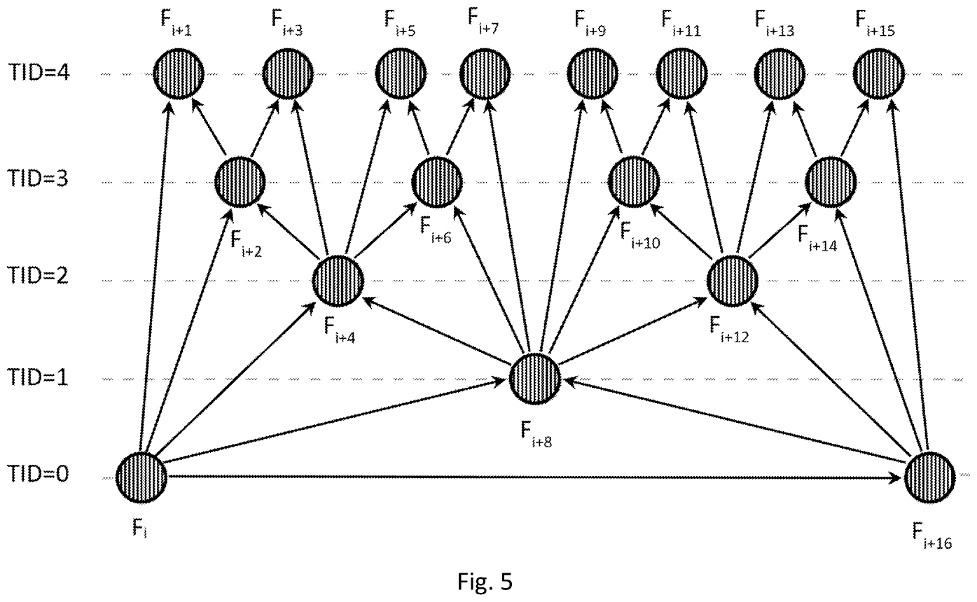

It can be determined, on the other hand, that frames have a different proportion in the final bit rate, based on their sequence and position in the used encoding structure. With regard to this, reference shall be made to FIG. 5. The circles represent frames with the illustration sequence. The arrows indicate the conventionally generated reference pictures, which can be used for the motion compensation. For example, the frame can use Fᵢ₊₄Fᵢ and Fᵢ₊₈ as reference. Frames with a temporal identifier 4 (TID=4) contribute less to the final bit rate in the hierarchical encoding structure than frames with a temporal identifier of TID≤3. This is mainly because they use their respective direct (previous/following) frame for the motion compensation, but which have almost identical content. In contrast, the frame Fᵢ₊₈ uses, for example, Fᵢ and Fᵢ₊₁₆ as reference pictures, but which are farther apart from one another.

For the following consideration, we assume that the approach proposed in the context of the invention reduces the bit rate for each frame by 5% compared to the previous approach. Due to the fact that frames with TID=4 contribute less to the final encoding gain/the final bit rate (assuming that 10% of the total bit rate can be attributed to TID=4), the proportion, which could be attained here by means of the invention, is correspondingly small (5% of 10%). The use of the method according to the invention could thus be forgone for this region because the contribution is rather small. Computing time/storage can thus be saved in order to keep the speed high or to provide it for regions, respectively, in which the method according to the invention makes a larger contribution to the final encoding gain/the final bit rate.

If it is assumed, e.g., that the gain would provide a final encoding gain of 3% by means of the method according to the invention when applied to all frames, the omission of the frames with TID=4 would decrease this final encoding gain to approximately 2.7%. In contrast, the encoder could be (more than) twice as fast.

Even if one were to apply the method according to the invention only to TID≤1, the omission of the other frames would decrease this final encoding gain to approximately 1%.

The decoder is logically informed about such a situation, if the encoder only encodes or does not encode, respectively, one or several frames with certain TIDs. Depending on the design, this can be used by a flag (reduced/not reduced) or by a code word (e.g. 1 for only TID=1, 2 only for TID=2, 4 only TID=3 or 3 for TID 1 and 2, . . . ), respectively.

It is important to note that the camera parameters CP and geometry data GD for the 3D scene geometry cannot only be provided once but repeatedly individually or in combination by the encoder to the decoder. A new set as well as an update can thereby be provided in each case.

What is claimed is:

1. A method for playback of a video stream by a client, wherein the video stream has frames from exactly one camera in relation to an object moving relative thereto, from different positions, having the steps of
receiving a video stream from an encoder,
decoding the received video stream using camera parameters and geometry data,
playing back the processed video stream.

2. The method according to claim 1, wherein the camera parameters are received from the encoder or are determined from the received video stream.

3. The method according to claim 1, wherein the geometry data is received from the encoder or is determined from the received video stream.

4. The method according to claim 1, wherein prior to receiving the video stream, the decoder signals its ability to process to the encoder.

5. The method according to claim 1, wherein the geometry data has depth data.

6. A device for carrying out a method according to claim 1.

7. A computer program product for setting up a data processing system for carrying out a method according to claim 1.

8. A method for providing a video stream by an encoder to a client, wherein the video stream has frames from exactly one camera in relation to an object moving relative thereto, from different positions, having the steps of
receiving frames from a camera in relation to an object from different positions in the form of a video stream
encoding the received video stream using camera parameters and geometry data,
streaming the video stream.

9. The method according to claim 8, wherein the camera parameters are received from an external source or are determined from the received video stream.

10. The method according to claim 8, wherein the geometry data is received from an external source or is determined from the received video stream.

11. The method according to claim 9, wherein the external source are a sensor and/or the cameras.

12. The method according to claim 8, wherein prior to streaming the video stream, the client signals its ability to process to the encoder.

13. The method according to claim 1, wherein the geometry data has depth data.

14. A device for carrying out a method according to claim 8.

15. A computer program product for setting up a data processing system for carrying out a method according to claim 8.
